(19) United States
(12) Patent Application Publication
(10) Pub. No.: US 2013/0146085 A1
(43) Pub. Date: Jun. 13, 2013

(54) GLASS SUBSTRATE CLEANING APPARATUS AND CLEANING METHOD

(71) Applicant: Hao Kou, Guangdong (CN)

(72) Inventor: Hao Kou, Guangdong (CN)

(73) Assignee: Shenzhen China Star Optoelectronics Technology Co., Ltd., Shenzhen (CN)

(21) Appl. No.: 13/381,300

(22) PCT Filed: Dec. 9, 2011
(86) PCT No.: PCT/CN11/83735

§ 371 Date: Dec. 28, 2011

(30) Foreign Application Priority Data
Dec. 7, 2011 (CN) 201110403570.1

(51) Int. Cl. B08B 3/12

(52) U.S. Cl. 134/1; 134/184

(57) ABSTRACT

The invention relates to a glass substrate cleaning apparatus and cleaning method. The glass substrate cleaning apparatus of the present invention includes a cleaning trough and first frequency generators for transmitting ultrasonic waves of a first frequency and second frequency generators for transmitting ultrasonic waves of a second frequency disposed at two sides of the cleaning trough. In the present invention, a cost is reduced and a good cleaning effect is reached by using the ultrasonic waves of different frequencies to clean a glass substrate.

### TECHNICAL FIELD OF THE INVENTION

The present invention involves a field of substrate cleaning, more particularly, a high-efficiency and low-cost cleaning apparatus and cleaning method for a glass substrate.

### BACKGROUND OF THE INVENTION

Currently, in the field of liquid crystal display (LCD), on the aspect of cleaning a glass substrate for manufacturing a LCD panel, different cleaning techniques are utilized for particles of different particle sizes. Generally, organic substance residue on the glass substrate is cleaned by plasma cleaning, particles of particle sizes greater than 10 μm are cleaned by brush plus shower cleaning, particles of particle sizes of 1˜10 μm are cleaned by pressure jet cleaning, and particles of particle sizes of 1˜5 μm are cleaned by double-liquid jet cleaning.

However, as the requirements of a huge size, a high aperture ratio and a low wire width of the LCD panel, the requirements of cleaning techniques for the glass substrate is getting higher to avoid defects such as disconnection and short circuits. A conventional glass substrate cleaning apparatus has the following shortcomings:

1. A high cost on machines is caused by utilizing different cleaning machines for particles of different particle sizes, working time is wasted during conversion among the various machines, and new particles are easy to be brought in;

2. The cleaning principle of the conventional cleaning machines is physical flushing, the cleaning effect to smaller particles which tenaciously attach thereon is not significant, further, consumption of distilled water and the additive solvent is greater.

Aiming to the above shortcomings of the conventional cleaning machines, an ultrasonic cleaning technique is developed to clean the particles on the surface of the glass substrate, that is, an ultrasonic wave is used in the cleaning liquid to clean the glass substrate. Compared to the cleaning principle of physical flushing of the original cleaning apparatus, the ultrasonic cleaning technique utilized the cavitation effect. The cavitation effect indicates cleaning the surface of the glass substrate by using inner bursts of tiny bubbles in the cleaning liquid. The inner bursts of the tiny bubbles are resulted from a pressure change of the liquid in the cleaning liquid. When the liquid is in a negative pressure state, a boiling point of the liquid is lowered, and therefore a lot of tiny bubbles are generated; when the liquid is in a positive pressure state, violent inner bursts of the tiny bubbles occur. Accordingly, the cleaning liquid has stirring and washing effects due to the cavitation phenomenon, and the surface of the glass substrate can be cleaned more properly. However, when the surface of the glass substrate is cleaned by using an ultrasonic wave, the ultrasonic wave generated by a vibrator of an ultrasonic frequency generator intends to lead to interference affects such as generation of a standing wave, so the cleaning of the ultrasonic wave to the glass substrate is influenced.

Therefore, there is a need for a glass substrate cleaning apparatus and cleaning method with a high efficiency and a low cost to solve the problems existing in the prior arts.

### SUMMARY OF THE INVENTION

An objective of the present invention is to provide a glass substrate cleaning apparatus and cleaning method with a high efficiency and a low cost to solve the problems of the higher cost, the poorer cleaning effect of the conventional cleaning apparatus and cleaning method.

To solve the above problems, technical solutions provided by the present invention are as follows:

The present invention relates to a glass substrate cleaning apparatus comprising a cleaning trough, wherein the cleaning apparatus comprises: first frequency generators each for generating an ultrasonic wave of a first frequency; and second frequency generators each for generating an ultrasonic wave of a second frequency; the first frequency generators and the second frequency generators are disposed at two sides of the cleaning trough; all of the first frequency generators and the second frequency generators have vibrators, the vibrators exposed from an inner wall of the cleaning trough, and the vibrators of the first frequency generators and the vibrators of the second frequency generators are arranged in alternate lines; a range of the first frequency is 40˜70 KHz, a range of the second frequency is 120˜470 KHz.

In the glass substrate cleaning apparatus of the present invention, the glass substrate cleaning apparatus further comprises a substrate support bracket, which is placed in the cleaning trough for supporting a substrate to be cleaned so that an angle between the substrate to be cleaned and a bottom plane of the cleaning trough is 30˜45 degree.

In the glass substrate cleaning apparatus of the present invention, the substrate support bracket comprises a bottom supporter contacting the bottom of the cleaning trough and at least one oblique supporter for placing the substrate to be cleaned, an angle between a plane of the bottom supporter and a plane of the oblique supporter is 30˜45 degree.

The present invention relates to a glass substrate cleaning apparatus comprising a cleaning trough, wherein the cleaning apparatus comprises: first frequency generators each for generating an ultrasonic wave of a first frequency; and second frequency generators each for generating an ultrasonic wave of a second frequency; the first frequency generators and the second frequency generators are disposed at two sides of the cleaning trough.

In the glass substrate cleaning apparatus of the present invention, a range of the first frequency is 40˜70 KHz, a range of the second frequency is 120˜170 KHz.

In the glass substrate cleaning apparatus of the present invention, all of the first frequency generators and the second frequency generators have vibrators, the vibrators are exposed from the inner wall of the cleaning trough, and the vibrators of the first frequency generators and the vibrators of the second frequency generators are arranged in alternate lines.

In the glass substrate cleaning apparatus of the present invention, an interval between two adjacent vibrators of the first frequency generators and the second frequency generators is 15˜50 cm.

In the glass substrate cleaning apparatus of the present invention, the glass substrate cleaning apparatus further comprises a substrate support bracket, which is placed in the cleaning trough for supporting a substrate to be cleaned so that an angle between the substrate to be cleaned and a bottom plane of the cleaning trough is 30˜45 degree.

In the glass substrate cleaning apparatus of the present invention, the substrate support bracket comprises a bottom supporter contacting the bottom of the cleaning trough and at least one oblique supporter for placing the substrate to be cleaned, an angle between a plane of the bottom supporter and a plane of the oblique supporter is 30˜45 degree.

The present invention further relates to a glass substrate cleaning method, which comprises steps of: A. placing a substrate to be cleaned on a substrate support bracket in a cleaning trough; B. injection cleaning liquid into the cleaning trough to cover the substrate to be cleaned with the cleaning liquid; C. transmitting an ultrasonic wave of a first frequency and an ultrasonic of a second frequency at the same time in the cleaning trough to execute ultrasonic cleaning to the substrate to be cleaned.

In the glass substrate cleaning method of the present invention, a range of the first frequency is 40˜70 KHz, a range of the second frequency is 120˜170 KHz.

In the glass substrate cleaning method of the present invention, the method further comprises a step before step A: providing first frequency generators each for generating an ultrasonic wave of a first frequency and second frequency generators each for generating an ultrasonic wave of a second frequency at two sides of the cleaning trough, vibrators of the first frequency generators and the vibrators of the second frequency generators are arranged in alternate lines, an interval between two adjacent vibrators of the first frequency generators and the second frequency generators is 15˜50 cm.

In the glass substrate cleaning method of the present invention, step A particularly comprises: placing the substrate support bracket in the cleaning trough, and then placing the substrate to be cleaned on the substrate support bracket in the cleaning trough so that an angle between the substrate to be cleaned and a bottom plane of the cleaning trough is 30˜45 degree.

In the glass substrate cleaning method of the present invention, a cleaning time in step C is 200˜280 seconds.

There are the following advantageous effects achieved by implementing the glass substrate cleaning apparatus and cleaning method of the present invention: the cost of the cleaning apparatus is low, the cleaning effect is good, so that the technical problems of higher cost and poorer cleaning effect in the conventional glass substrate cleaning apparatus and cleaning method.

For a better understanding of the aforementioned content of the present invention, a preferred embodiment is described in detail in conjunction with the appending figure as follows:

### BRIEF DESCRIPTION OF THE DRAWINGS

FIG. 1 is a schematic structural diagram of a glass substrate cleaning apparatus in accordance with a preferred embodiment of the present invention;

FIG. 2 is a schematic structural diagram of a section A-A in FIG. 1;

FIG. 3 is a schematic structural diagram of a section B-B in FIG. 1;

FIG. 4 is a curve diagram showing relationships between an interval between vibrators of ultrasonic frequency generators of the glass substrate cleaning apparatus in accordance with the preferred embodiment of the present invention and amounts of residual particles with particle sizes of 2.0 μm and 2.5 μm;

FIG. 5 is a curve diagram showing relationships between an interval between vibrators of ultrasonic frequency generators of the glass substrate cleaning apparatus in accordance with the preferred embodiment of the present invention and amounts of residual particles with particle sizes of 1.2 μm and 2.2 μm;

FIG. 6 is a curve diagram showing relationships between an angle between a substrate to be cleaned and a bottom plane of a cleaning trough in the glass substrate cleaning apparatus in accordance with the preferred embodiment of the present invention and amounts of residual particles with particle sizes of 2.0 μm and 2.5 μm;

FIG. 7 is a curve diagram showing relationships between an angle between a substrate to be cleaned and a bottom plane of a cleaning trough in the glass substrate cleaning apparatus in accordance with the preferred embodiment of the present invention and amounts of residual particles with particle sizes of 1.2 μm and 2.2 μm;

FIG. 8 is a flow chart of a glass substrate cleaning method in accordance with a preferred embodiment of the present invention.

### DETAILED DESCRIPTION OF THE INVENTION

The respective embodiments will be described with reference to the appending drawings as follows, and they are specific embodiments for exemplifying that the present invention is able to be put into practice.

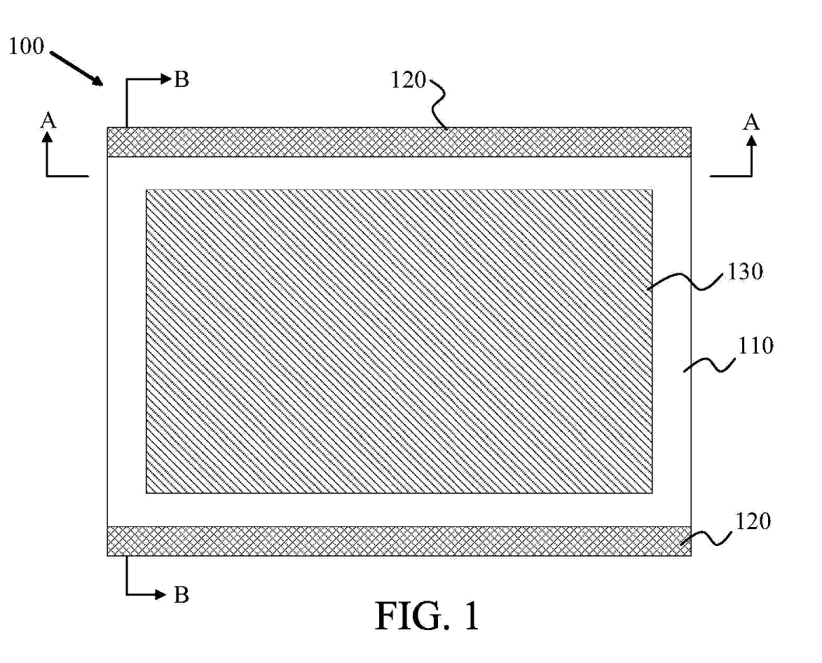

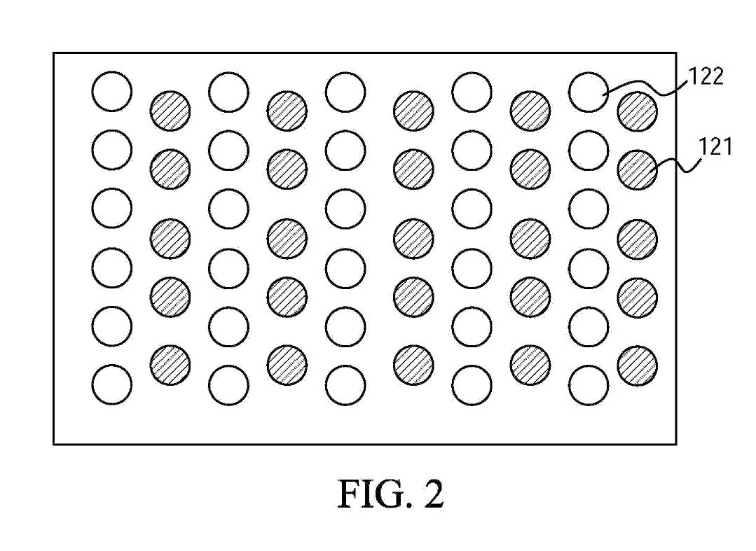

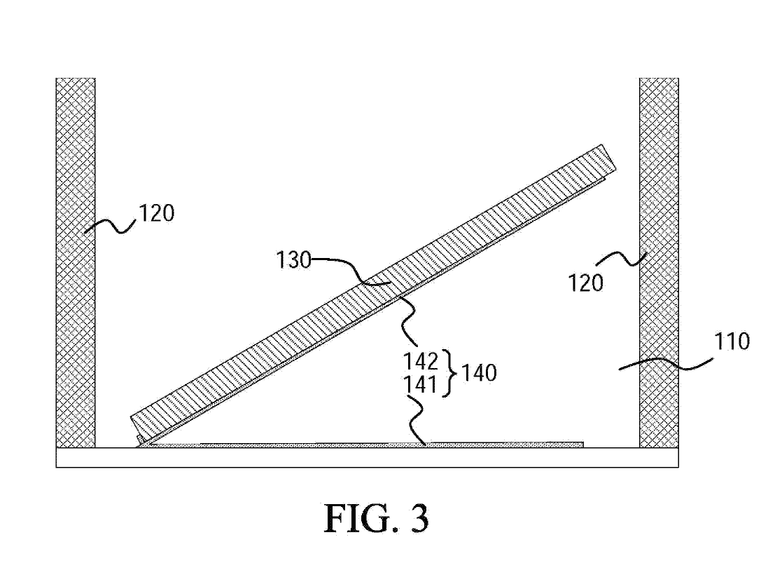

FIG. 1 is a schematic structural diagram of a glass substrate cleaning apparatus in accordance with a preferred embodiment of the present invention, FIG. 2 is a schematic structural diagram of a section A-A in FIG. 1, FIG. 3 is a schematic structural diagram of a section B-B in FIG. 1. The present invention relates to a glass substrate cleaning apparatus 100, which comprises a cleaning trough 110 as well as first frequency generators 121 and second frequency generator 122 disposed at two sides of the cleaning trough 110, wherein the first frequency generator 121 is used for generating an ultrasonic wave of a first frequency, the second frequency generator 122 is used for generating an ultrasonic of a second frequency.

When cleaning, a substrate to be cleaned 130 is placed in the cleaning trough 110, and a cleaning liquid is injected into the cleaning trough 110 to cover the substrate to be cleaned 130 with the cleaning liquid. An ultrasonic cleaning is executed to the substrate to be cleaned 130 by the first frequency generators 121 and the second frequency generators 122 disposed at the two sides of the cleaning trough 110 transmitting the ultrasonic waves of the first frequency and the ultrasonic waves of the second frequency at the same time.

In the present embodiment, a range of the first frequency of the ultrasonic wave transmitted by the first frequency generator 121 is preferably 40˜70 KHz, a range of the second frequency of the ultrasonic wave transmitted by the second frequency generator 122 is preferably 120˜170 KHz. The first frequency generator of 40˜70 KHz is mainly used for cleaning particles with particle sizes of 2.0˜2.5 μm, the second frequency generator of 120˜170 KHz is mainly used for cleaning particles with particle sizes of 1.0˜1.8 μm.

Each of the first frequency generators 121 and the second frequency generators 122 comprises an ultrasonic generating device and a vibrator exposed from an inner wall of the cleaning trough 110. The vibrators of the first frequency generators 121 and the vibrators of the second frequency generators 122 are distributed in alternate lines, as shown in FIG. 2, in which the first frequency generators 121 and the second frequency generators 122 are indicated by the vibrators exposed from the inner wall of the cleaning trough 110, respectively.

Preferably, an interval between two adjacent vibrators of the frequency generators is 15˜50 cm. The cleaning effect of two-frequency ultrasonic waves and the interval between the vibrators highly interrelate with each other. As proved by experiments, an optimal cleaning effect can be reached when the vibrators of the first frequency generators 121 and the vibrators of the second frequency generators 121 are distributed in alternate lines and the interval between the adjacent vibrators of the frequency generators is 15˜50 cm, the details can be referred to the following experimental data.

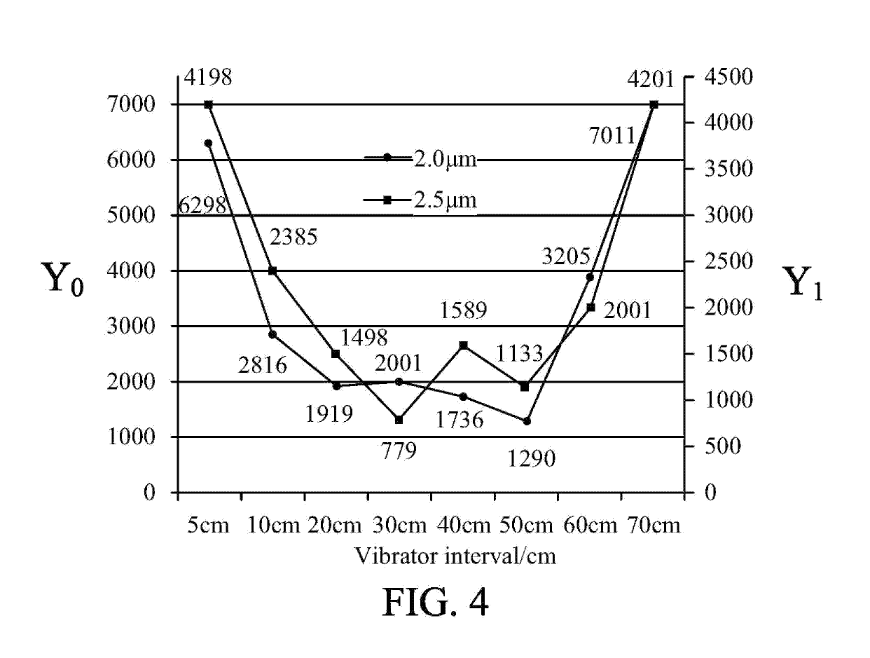

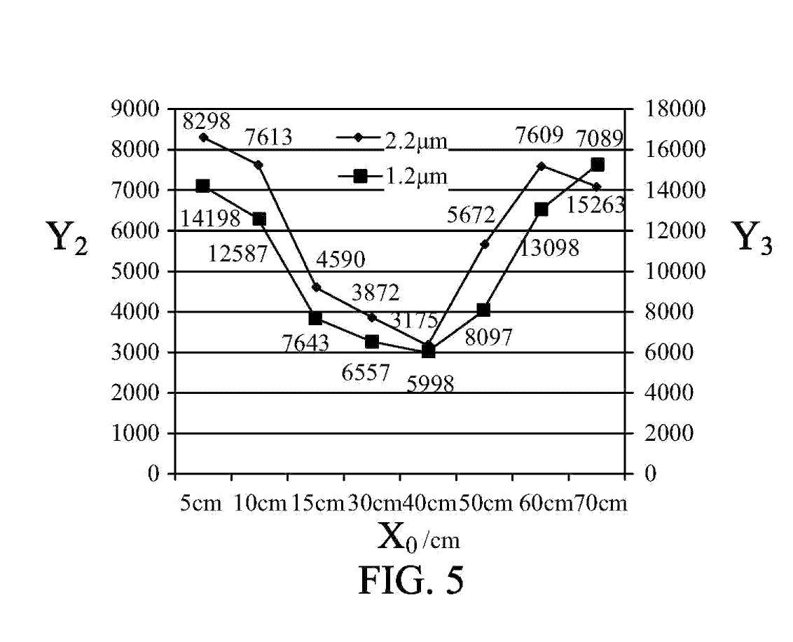

Particularly refer to FIG. 4 and FIG. 5, FIG. 4 is a curve diagram showing relationships between the interval between the vibrators of the frequency generators and amounts of residual particles with particle sizes of 2.0 μm and 2.5 μm, FIG. 5 is a curve diagram showing relationships between the interval between the vibrators of the frequency generators and amounts of residual particles with particle sizes of 1.2 μm and 2.2 μm, wherein X₀ is the interval between the vibrators, Y₀ is the amount of the residual particles with the particle size of 2.0 μm, Y₁ is the amount of the residual particles with the particle size of 2.5 μm, Y₂ is the amount of the residual particles with the particle size of 2.2 μm, Y₃ is the amount of the residual particles with the particle size of 1.2 μm. The amounts of particles with various particle sizes in the liquid are counted by a liquid particle counter (LPC) to indicate a clean degree of a surface of the glass substrate. As can be seen in FIG. 4, under a condition that other experimental parameters are constant, when the interval between the vibrators is greater than 50 cm or less than 20 cm, the amounts of the residual particles of 2.0 μm and the residual particles of 2.5 μm are significantly increased. As can be seen in FIG. 5, when the interval between the vibrators is greater than 50 cm or less than 15 cm, the amounts of the residual particles of 1.2 μm and the residual particles of 2.2 μm are also significantly increased. Therefore, it can be found out that the optimal cleaning effect of the two-frequency ultrasonic cleaning is reached when the interval between the adjacent vibrators of the frequency generators is 15˜50 cm.

The glass substrate cleaning apparatus 100 further comprises a substrate support bracket 140 for placing the substrate to be cleaned 130, the substrate support bracket 140 comprises a bottom supporter 141 and at least one oblique supporter 142. The bottom supporter 141 contacts the bottom of the cleaning trough 110. The oblique supporter is used for placing the substrate to be cleaned 130. A predetermined angle is formed between a plane of the bottom supporter 141 and a plane of the oblique supporter 142, so that a corresponding angle is formed between the substrate to be cleaned 130 placed on the oblique supporter 142 and the bottom plane of the cleaning trough 110. Preferably, the angle between a plane of the bottom supporter 141 and a plane of the oblique supporter 142 is 30˜45 degree, so that the angle between the substrate to be cleaned 130 and the bottom plane of the cleaning trough 110 is also 30˜45 degree. The cleaning effect of two-frequency ultrasonic waves and the angle between the substrate to be cleaned 130 and the bottom plane of the cleaning trough 110 highly interrelate with each other. As proved by experiments, an optimal cleaning effect can be reached when the angle between the substrate to be cleaned 130 and the bottom plane of the cleaning trough 110 is 30˜45 degree, the details can be referred to the following experimental data.

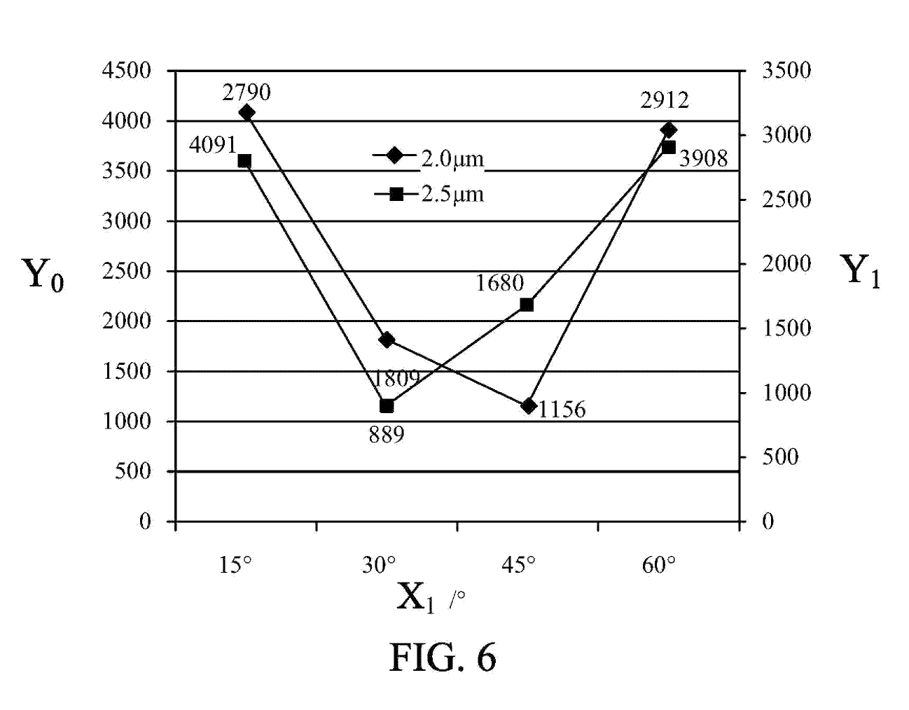

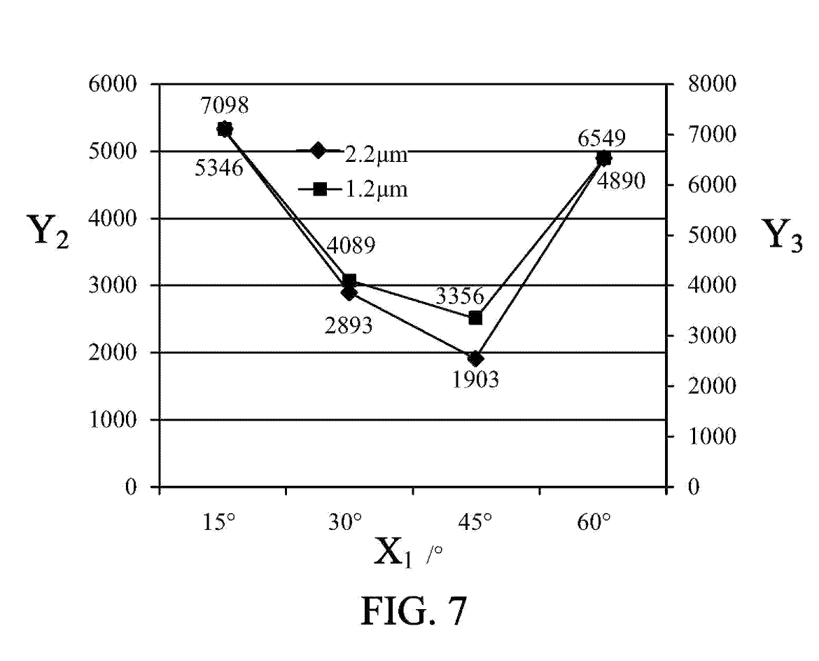

It is described as follows that the optimal cleaning effect can be reached when the angle between the substrate to be cleaned 130 and the bottom plane of the cleaning trough 110 is 30˜45 degree by using the experimental data. Particularly refer to FIG. 6 and FIG. 7, FIG. 6 is a curve diagram showing relationships between the angle between the substrate to be cleaned 130 and the bottom plane of the cleaning trough 110 and amounts of residual particles with particle sizes of 2.0 μm and 2.5 μm, FIG. 7 is a curve diagram showing relationships between an angle between the substrate to be cleaned 130 and the bottom plane of the cleaning trough 110 and amounts of residual particles with particle sizes of 1.2 μm and 2.2 μm, wherein X₁ is the angle between the substrate to be cleaned 130 and the bottom plane of the cleaning trough 110, Y₀ is the amount of the residual particles with the particle size of 2.0 μm, Y₁ is the amount of the residual particles with the particle size of 2.5 μm, Y₂ is the amount of the residual particles with the particle size of 2.2 μm, Y₃ is the amount of the residual particles with the particle size of 1.2 μm. The amounts of particles with various particle sizes in the liquid are counted by the liquid particle counter (LPC) to indicate a clean degree of a surface of the glass substrate. As can be seen in FIG. 6, under a condition that other experimental parameters are constant, when the angle between the substrate to be cleaned 130 and the bottom plane of the cleaning trough 110 is greater than 45 degree or less than 30 degree, the amounts of the residual particles of 2.0 μm and the residual particles of 2.5 μm are significantly increased. As can be seen in FIG. 7, when the angle between the substrate to be cleaned 130 and the bottom plane of the cleaning trough 110 is greater than 45 degree or less than 30 degree, the amounts of the residual particles of 1.2 μm and the residual particles of 2.2 μm are also significantly increased. Therefore, it can be found out that the optimal cleaning effect of the two-frequency ultrasonic cleaning is reached when the angle between the substrate to be cleaned 130 and the bottom plane of the cleaning trough 110 is 30˜45 degree.

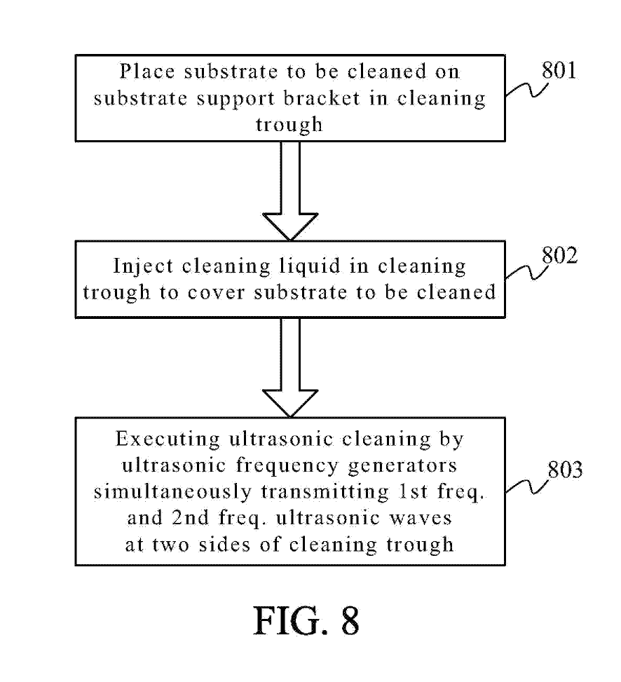

The present invention also relates to a glass substrate cleaning method. Particularly refer to FIG. 8, which is a flow chart of the glass substrate cleaning method in accordance with a preferred embodiment of the present invention. The glass substrate cleaning method starts at:

Step 801, placing the substrate to be cleaned 130 on the substrate support bracket 140 in the cleaning trough 110,

Step 802, injecting the cleaning liquid into the cleaning trough 110 to cover the substrate to be cleaned 130 with the cleaning liquid,

Step 803, transmitting the ultrasonic wave of the first frequency and the ultrasonic wave of the second frequency at the same time to execute ultrasonic cleaning to the substrate to be cleaned 130.

The step 801 particularly comprises:

Step 8011, providing the first frequency generators 121 for transmitting the ultrasonic waves of the first frequency and the second frequency generators 122 for transmitting the ultrasonic waves of the second frequency at the two sides of the cleaning trough 110, the vibrators of the first frequency generators 121 and the vibrators of the second frequency generators 122 are distributed in alternate lines. The interval between adjacent vibrators of the frequency generators (i.e. the first frequency generators 121 and the second frequency generators) is 15˜50 cm. The range of the first frequency is preferably 40˜70 KHz, the range of the second frequency is preferably 120˜170 KHz.

Step 8012, putting the substrate support bracket 140 in the cleaning trough 110, wherein the angle between the plane of the bottom supporter 141 of the substrate support bracket 140 and the plane of the oblique supporter 142 thereof is 30˜45 degree, and then placing the substrate to be cleaned 130 on the oblique supporter 142 so that the angle between the substrate to be cleaned 130 and the bottom plane of the cleaning trough 110 is 30˜45 degree.

The step 802 particularly comprises injecting the cleaning liquid (e.g. deionized water) into the cleaning trough 110 to cover the whole substrate to be cleaned 130 with the cleaning liquid.

The step 803 particularly comprises activating the frequency generators to transmit the ultrasonic waves to clean the substrate to be cleaned, wherein the vibrators of the first frequency generators 121 transmit the ultrasonic waves of the first frequency to execute the ultrasonic cleaning to the substrate to be cleaned 130, at the same time, the vibrators of the second frequency generators 122 transmit the ultrasonic waves of the second frequency to execute the ultrasonic cleaning to the substrate to be cleaned 130.

The cleaning time in the step 803 is preferably 200˜280 seconds. The cleaning can be done at a time for 200˜280 seconds. As such, operation processes can be saved. Alternatively, the cleaning can be divided into several parts, for example, 3 parts, and each part takes 90 seconds. As such a better cleaning effect can be reached. A user may choose a proper manner as required.

In the glass substrate cleaning apparatus and cleaning method of the present invention, frequency generators of two frequencies are provided and used. The ultrasonic waves of different frequencies are able to effectively remove particles of different particle sizes. Further, the ultrasonic waves of two frequencies are used to clean the surface of the glass substrate, the ultrasonic waves of the two frequencies can be superimposed with each other, and thus interference effects such as the standing wave generated in the single-frequency ultrasonic cleaning can be effectively eliminated. In addition, the powers of the frequency generators are adjustable, and the user can control output powers of the ultrasonic waves according to the dirty degree of the surface of the glass substrate.

Preferably, the ultrasonic waves of two frequencies which are quite different from each other are used here to clean the glass substrate at the same time, the particles of various particle sizes are effectively removed, and the interference effects such as the standing wave generated in ultrasonic cleaning are further eliminated when the frequencies of the two ultrasonic waves are quite different from each other. The frequency range of the ultrasonic waves used in the present invention is wider, and therefore the particle size range of the particles which can be cleaned is broader, and therefore the cost of the cleaning apparatus and the processing time are saved, so the manufacture cost is saved.

To sum up, the present invention has been disclosed as the preferred embodiments above, however, the above preferred embodiments are not described for limiting the present invention, various modifications, alterations and improvements can be made by persons skilled in this art without departing from the spirits and principles of the present invention, and therefore the protection scope of claims of the present invention is based on the range defined by the claims.

What is claimed is:

1. A glass substrate cleaning apparatus comprising a cleaning trough, characterized in that the glass substrate cleaning apparatus comprises:
first frequency generators for transmitting ultrasonic waves of a first frequency; and
second frequency generators for transmitting ultrasonic waves of a second frequency;
the first frequency generators and the second frequency generators being disposed at two sides of the cleaning trough;
each of the first frequency generators and the second frequency generators having a vibrator exposed from an inner wall of the cleaning trough, and the vibrators of the first frequency generators and the second frequency generators being distributed in alternate lines;
a range of the first frequency being 40˜70 KHz, and a range of the second frequency being 120˜170 KHz.

2. The glass substrate cleaning apparatus according to claim 1, characterized in that an interval between adjacent vibrators of the first frequency generators and the second frequency generators is 15˜50 cm.

3. The glass substrate cleaning apparatus according to claim 1, characterized in that the glass substrate cleaning apparatus further comprises a substrate support bracket, which is placed in the cleaning trough for placing a substrate to be cleaned so that an angle between the substrate to be cleaned and a bottom plane of the cleaning trough is 30˜45 degree.

4. The glass substrate cleaning apparatus according to claim 3, characterized in that the substrate support bracket comprises a bottom supporter for contacting the bottom of the cleaning trough and at least one oblique supporter for placing the substrate to be cleaned, an angle between a plane of the bottom supporter and a plane of the oblique supporter is 30˜45 degree.

5. A glass substrate cleaning apparatus comprising a cleaning trough, characterized in that the glass substrate cleaning apparatus comprises:
first frequency generators for transmitting ultrasonic waves of a first frequency; and
second frequency generators for transmitting ultrasonic waves of a second frequency;
the first frequency generators and the second frequency generators being disposed at two sides of the cleaning trough.

6. The glass substrate cleaning apparatus according to claim 5, characterized in that a range of the first frequency is 40˜70 KHz, and a range of the second frequency is 120˜170 KHz.

7. The glass substrate cleaning apparatus according to claim 5, characterized in that each of the first frequency generators and the second frequency generators has a vibrator exposed from an inner wall of the cleaning trough, and the vibrators of the first frequency generators and the second frequency generators are distributed in alternate lines

8. The glass substrate cleaning apparatus according to claim 7, characterized in that an interval between adjacent vibrators of the first frequency generators and the second frequency generators is 15˜50 cm.

9. The glass substrate cleaning apparatus according to claim 5, characterized in that the glass substrate cleaning apparatus further comprises a substrate support bracket, which is placed in the cleaning trough for placing a substrate to be cleaned so that an angle between the substrate to be cleaned and a bottom plane of the cleaning trough is 30˜45 degree.

10. The glass substrate cleaning apparatus according to claim 9, characterized in that the substrate support bracket comprises a bottom supporter for contacting the bottom of the cleaning trough and at least one oblique supporter for placing the substrate to be cleaned, an angle between a plane of the bottom supporter and a plane of the oblique supporter is 30˜45 degree.

11. A glass substrate cleaning method, characterized in that, comprising:
A. placing a substrate to be cleaned in a cleaning trough;
B. injecting a cleaning liquid into the cleaning trough to cover the substrate to be cleaned with the cleaning liquid;
C. transmitting an ultrasonic wave of a first frequency and an ultrasonic wave of a second frequency at the same time to execute an ultrasonic cleaning to the substrate to be cleaned.

12. The glass substrate cleaning method according to claim 11, characterized in that a range of the first frequency is 40˜70 KHz, and a range of the second frequency is 120˜170 KHz.

13. The glass substrate cleaning method according to claim 11, characterized in that a step is further comprised before step A:
providing first frequency generators for transmitting ultrasonic waves of a first frequency and second frequency generators for transmitting ultrasonic waves of a second frequency at two sides of the cleaning trough, vibrators of the first frequency generators and the second frequency generators are distributed in alternate lines, and an interval between adjacent vibrators of the first frequency generators and the second frequency generators is 15˜50 cm.

14. The glass substrate cleaning method according to claim 11, characterized in that the step A particularly comprises: putting a substrate support bracket in the cleaning trough, and then placing the substrate to be cleaned on the substrate support bracket so that an angle between the substrate to be cleaned and a bottom plane of the cleaning trough is 30˜45 degree.

15. The glass substrate cleaning method according to claim 11, characterized in that a cleaning time in the step C is 200˜280 seconds.
